(19) United States
(12) Patent Application Publication
(10) Pub. No.: US 2025/0237555 A1
(43) Pub. Date: Jul. 24, 2025

(54) APPARATUSES, SYSTEMS, AND METHODS FOR RELAXATION-OSCILLATOR-BASED THERMAL SENSING

(71) Applicant: Advanced Micro Devices, Inc., Santa Clara, CA (US)

(72) Inventors: Ravinder Reddy Rachala, Austin, TX (US); Samuel Naffziger, Fort Collins, CO (US)

(73) Assignee: Advanced Micro Devices, Inc., Santa Clara, CA (US)

(21) Appl. No.: 17/982,572

(22) Filed: Nov. 8, 2022

(51) Int. Cl. G01K 3/00; G01K 3/04; G01K 7/00

(52) U.S. Cl. CPC G01K 3/005; G01K 3/04; G01K 7/00

(57) ABSTRACT

The disclosed apparatus for relaxation-oscillator-based thermal sensing can include a first oscillation count module. The first oscillation count module can include a first counter configured to count a first number of oscillations produced by a first relaxation oscillator. The apparatus can also include a second oscillation count module. The second oscillation count module can include a second counter configured to count a second number of oscillations produced by a second relaxation oscillator. The apparatus can additionally include a subtraction module configured to subtract the second number of oscillations from the first number of oscillations to generate a count difference. Various other apparatuses, systems, and methods are also disclosed.

### BACKGROUND

A thermal sensor in a processor core can measure the temperature of the core to identify overheating.

### BRIEF DESCRIPTION OF THE DRAWINGS

The accompanying drawings illustrate a number of example implementations and variations and are a part of the specification. Together with the following description, these drawings demonstrate and explain various principles of the present disclosure.

FIG. 1 is a block diagram of an example apparatus for relaxation-oscillator-based thermal sensing.

FIG. 2 is a block diagram of an additional example apparatus for relaxation-oscillator-based thermal sensing.

FIG. 3 is a block diagram of an example chip incorporating multiple instances of the apparatus of FIG. 2.

FIG. 4 is a block diagram illustrating hotspots on the example chip of FIG. 3.

FIG. 5 is a diagram of an example circuit for relaxation-oscillator-based thermal sensing.

FIG. 6 is an illustration of example oscillations of an apparatus for relaxation-oscillator-based thermal sensing.

FIG. 7 is an illustration of an example correspondence between oscillations and temperature.

FIG. 8 is an illustration of an example temperature measurements by an example apparatus for relaxation-oscillator based thermal sensing.

FIG. 9 is an illustration of an example thermal alarm by an example apparatus for relaxation-oscillator based thermal sensing.

FIG. 10 is a flow diagram of an example method for relaxation-oscillator based thermal sensing.

Throughout the drawings, identical reference characters and descriptions indicate similar, but not necessarily identical, elements. While the example implementations and variations described herein are susceptible to various modifications and alternative forms, specific implementations have been shown by way of example in the drawings and will be described in detail herein. However, the example implementations described herein are not intended to be limited to the particular forms disclosed. Rather, the present disclosure covers all modifications, equivalents, and alternatives falling within the scope of the appended claims.

### DETAILED DESCRIPTION OF EXAMPLE IMPLEMENTATIONS

The present disclosure is generally directed to apparatuses, systems, and methods for relaxation-oscillator-based thermal sensing. A pair of relaxation-based oscillators can provide the basis for a digital thermal sensor, e.g., by determining temperature based on the frequency difference (e.g., count difference) between the two oscillators. The relaxation oscillators will oscillate at a greater frequency with greater leakage. Because leakage is correlated with temperature, a higher oscillation count can indicate a higher temperature. To improve precision, two relaxation oscillators can run in parallel, one acting as a control, in order to account for sources of oscillation delay unrelated to temperature. The oscillation count of the control oscillator can be subtracted from the primary oscillation count of the primary. Thermal alarm logic can generate signals when the current temperature exceeds tracked recent average temperature (based on sampled oscillator counts) and/or a count from a known cool spot. Alarm signals can serve as input to throttler logic. The relaxation-oscillator-based thermal sensors described herein can be simple (taking a small area, using low-level metals, using only digital elements, etc.), allowing for a high density of sensors and a precise and accurate detection of hot spots. Additionally, these thermal sensors can have a fast response time. The improved detection of hot spots can allow for efficient and precise thermal management that balances heat reduction and performance of an integrated circuit, such as a processor core. In general, the area efficiency and low complexity of integrating the thermal sensors described herein may make fine-grained thermal sensing practical, thereby allowing for more accurate thermal management of processors, stacked dies, and/or systems.

In one implementation, an apparatus for relaxation-oscillator-based thermal sensing can include a first oscillation count module. The first oscillation count module can include a first counter configured to count a first number of oscillations produced by a first relaxation oscillator. The apparatus can also include a second oscillation count module. The second oscillation count module can include a second counter configured to count a second number of oscillations produced by a second relaxation oscillator. The apparatus can additionally include a subtraction module configured to subtract the second number of oscillations from the first number of oscillations to generate a count difference.

In some implementations, the first oscillation count module and the second oscillation count module can be adjacent to each other.

In some implementations, the first count module can also include the first relaxation oscillator, the first relaxation oscillator being configured to produce a first oscillating voltage. The second count module can also include the second relaxation oscillator, the second relaxation oscillator being configured to produce a second oscillating voltage.

In some implementations, the first relaxation oscillator can include a first voltage comparator configured to compare the first oscillating voltage with a first reference voltage, where the first counter is configured to count an oscillation based on output from the first voltage comparator. The second relaxation oscillator can include a second voltage comparator configured to compare the second oscillating voltage with a second reference voltage, where the second counter is configured to count an oscillation based on output from the second voltage comparator.

In some implementations, the first reference voltage and the second reference voltage can differ. Additionally or alternatively, a rate of discharge of the first relaxation oscillator can differ from a rate of discharge of the second relaxation oscillator.

In some implementations, the first oscillation count module can also include a first reset delay element configured to delay an output signal from the first voltage comparator. The second oscillation count module can also include a second reset delay element configured to delay an output signal from the second voltage comparator. The first reset delay element and the second reset delay element can be configured to produce differing delays.

In some implementations, the first oscillation count module and the second oscillation count module can have substantially the same design except for one or more of (1) differing rates of discharge for the first and second relaxation oscillators, (2) differing reference voltages used by a first voltage comparator of the first relaxation oscillator and a second voltage comparator of the second relaxation oscillator, and (3) differing reset delays.

In some implementations, the apparatus can be configured to occupy only metal layers in a metal stack at or below the fourth metal layer.

In some implementations, the apparatus can be configured to use digital voltage and not to use analog voltage.

In some implementations, the first relaxation oscillator can include a first metal-oxide-semiconductor field-effect transistor configured to leak charge and the second relaxation oscillator can include a second metal-oxide semiconductor field-effect transistor configured to leak charge.

In some implementations, the apparatus can also include a frequency module configured to divide the count difference by a period of time to output a current temperature value.

In some implementations, the apparatus can also include an averaging module configured to average the current temperature value over a period of time to output an average temperature value.

In some implementations, the apparatus can also include a comparison module configured to compare the average temperature value with the current temperature value. The comparison module can also generate a temperature alarm signal in response to the current temperature value exceeding the average temperature value by a predetermined amount. Additionally or alternatively, the comparison module can be configured to compare the average temperature value with a baseline temperature value. The comparison module can then generate a temperature alarm signal in response to the current temperature value exceeding the baseline temperature value by a predetermined amount.

In one implementation, a semiconductor chip device can include one or more logic circuit structures and a thermal sensor. The thermal sensor can include a first oscillation count module. The first oscillation count module can include a first relaxation oscillator configured to produce a first oscillating voltage and a first counter configured to count a first number of oscillations produced by the first relaxation oscillator. The thermal sensor can also include a second oscillation count module. The second oscillation count module can include a second relaxation oscillator configured to produce a second oscillating voltage and a second counter configured to count a second number of oscillations produced by the second relaxation oscillator. The thermal sensor can additionally include a subtraction module configured to subtract the second number of oscillations from the first number of oscillations to generate a count difference.

In some implementations, the semiconductor chip device can also include an alarm module configured to generate, based at least in part on the count difference, a temperature alarm signal.

In some implementations, the semiconductor chip device can also include a remediation module configured to, in response to the temperature alarm signal, perform a remediation action. The remediation action can include any of a variety of actions, including (1) reducing a clock speed of the semiconductor chip device, (2) reducing a voltage supply to the semiconductor chip device, and/or (3) throttling at least one task performed by the semiconductor chip device.

In one implementation, a method for relaxation-oscillator-based thermal sensing can include (1) producing a first oscillating voltage via a first relaxation oscillator, (2) counting a first number of oscillations of the first oscillating voltage, (3) producing a second oscillating voltage via a second relaxation oscillator, (4) counting a second number of oscillations of the second oscillating voltage, and (5) subtracting the second number of oscillations from the first number of oscillations to generate a count difference.

Features from any of the example implementations and variations described herein can be used in combination with one another in accordance with the general principles described herein. These and other implementations, features, and advantages will be more fully understood upon reading the following detailed description in conjunction with the accompanying drawings and claims.

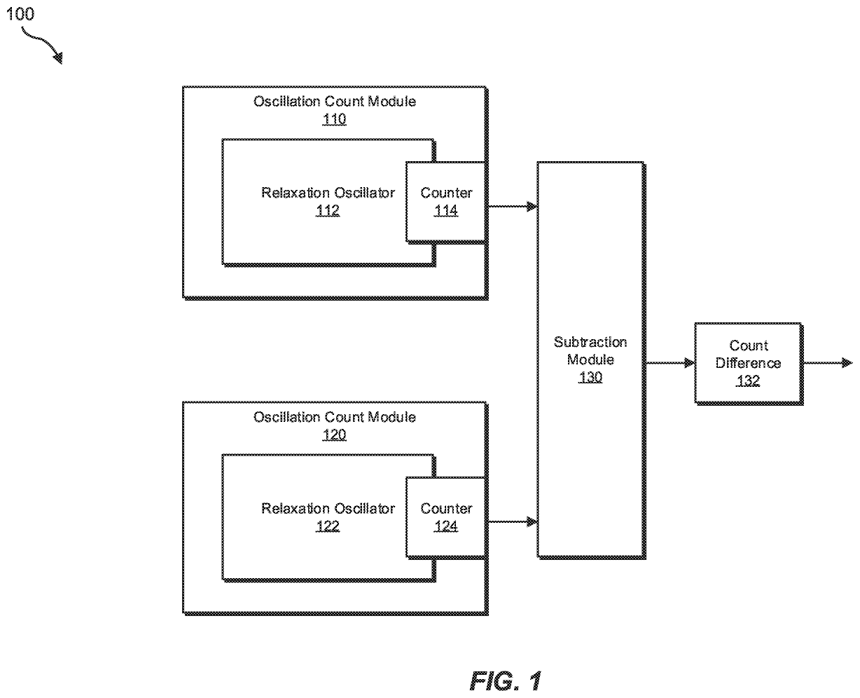

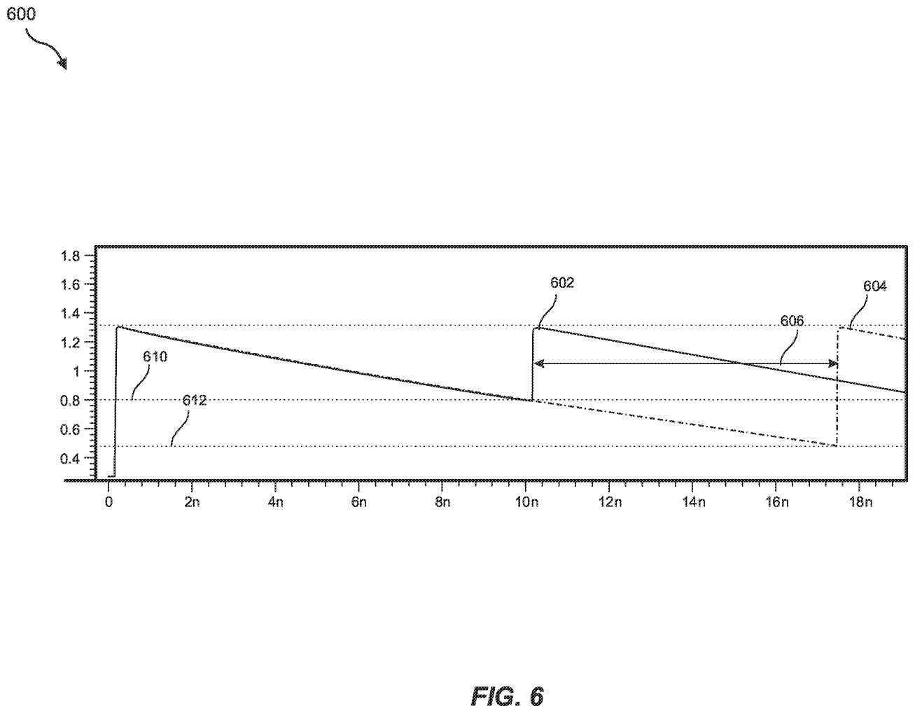

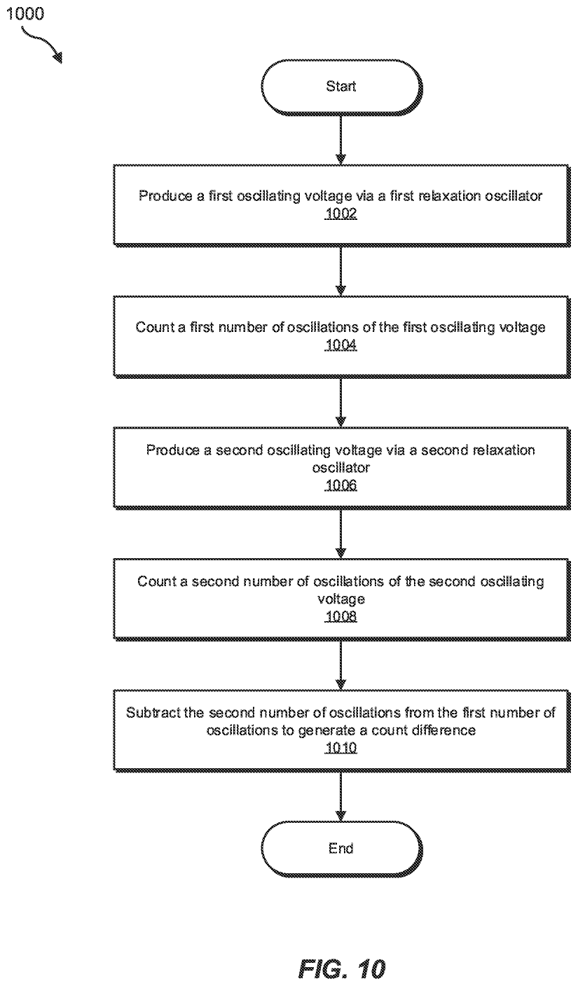

The following will provide, with reference to FIGS. 1-5, detailed descriptions of example apparatuses and systems for relaxation-oscillator-based thermal sensing. Detailed descriptions of corresponding illustrations of example behaviors and measurements of relaxation-oscillator based thermal sensors will be provided in connection with FIGS. 6-9. Detailed descriptions of corresponding methods will also be provided in connection with FIG. 10.

FIG. 1 is a block diagram of an example apparatus 100 for relaxation-oscillator-based thermal sensing. As illustrated in this figure, example apparatus 100 can include one or more modules 102 for performing one or more tasks. As will be explained in greater detail below, modules 102 can include an oscillation count module 110, an oscillation count module 120, and a subtraction module 130. Although illustrated as separate elements, one or more of modules 102 in FIG. 1 can represent portions of a single module. As used herein, the term “relaxation oscillator” can refer to any circuit that produces an oscillating signal that is affected by the temperature at the circuit. Thus, while many of the examples provided herein refer to relaxation oscillators, in various embodiments oscillators of various topologies (and not only, e.g., a relaxation topology) may be used.

In certain implementations, one or more of the modules described herein can represent one or more circuits that, when activated, can perform (or cause other parts of a computing device to perform) one or more tasks.

In some implementations, oscillation count module 110 can include a relaxation oscillator 112 and oscillation count module 120 can include a relaxation oscillator 122. Relaxation oscillators 112 and 122 can represent any type of relaxation oscillator whose behavior varies under different temperature conditions. For example, relaxation oscillators 112 and 122 can represent leakage-based relaxation oscillators that leak charge. Thus, for example, relaxation oscillators 112 and 122 can oscillate at higher frequencies when leaking charge more quickly. In addition, relaxation oscillators 112 and 122 can leak charge more quickly at higher temperatures. Thus, relaxation oscillators 112 and 122 can oscillate at higher frequencies at higher temperatures. In various implementations, relaxation oscillators 112 and 122 can be substantially adjacent to each other (e.g., highly proximate to each other). Accordingly, relaxation oscillators 112 and 122 can be subject to the same temperature conditions as well as other shared conditions (such as the same supply voltage, as will be discussed in greater detail below).

While relaxation oscillators 112 and 122 can vary behavior based on temperature conditions, in some examples other factors can influence the behavior of relaxation oscillators 112 and 122. For example, in some implementations variations in supply voltage to relaxation oscillators 112 and 122 can impact the frequencies of relaxation oscillators 112 and 122. Accordingly, the behavior relaxation oscillator 112 or relaxation oscillator 122 alone can correlate imperfectly with temperature. To control for factors other than temperature, relaxation oscillators 112 and 122 can be implemented to be subject to the same potentially confounding factors that can affect oscillation behavior. Thus, for example, relaxation oscillators 112 and 122 can operate on the same supply voltage. In addition, relaxation oscillators 112 and 122 can be configured to oscillate at different rates (i.e., at the same temperature). For example, in some implementations relaxation oscillators 112 and 122 can include voltage comparators that use different reference voltages. As used herein, the term “voltage comparator” can refer to any device that compares two voltages (e.g., a primary voltage to track and a stable “reference voltage”) and outputs a signal indicating which voltage is greater.

Additionally or alternatively to using voltage comparators that use different reference voltages, in some implementations relaxation oscillators 112 and 122 can use different leakage devices that leak charge at different rates. Thus, the difference in behavior between relaxation oscillators 112 and 122 can be due primarily to factors influenced by temperature. In this manner, one relaxation oscillator can be understood as effectively acting as a control to the other relaxation oscillator (e.g., relaxation oscillator 112 can be used to measure temperature with relaxation oscillator 122 being used as a control).

Inasmuch as the difference in behavior between relaxation oscillators 112 and 122 can be attributed to temperature, by subtracting the behavior of, e.g., relaxation oscillator 122 from relaxation oscillator 112, the difference of the behaviors of relaxation oscillators 112 and 122 can act as a proxy for temperature. To this end, a subtraction module 130 can isolate the difference in behavior between oscillation count modules 110 and 120. Thus, for example, in some implementations oscillation count module 110 can include a counter 114 that counts oscillations of relaxation oscillator 112 and oscillation count module 120 can include a counter 124 that counts oscillations of relaxation oscillator 122. Subtraction module 130 can subtract the value of counter 124 from the value of counter 114 to produce a count difference 132 that represents a difference in oscillation frequencies between relaxation oscillators 112 and 122 and, therefore, can correlate with temperature over a period of time. As used herein, the term “counter” can refer to any circuit that provides, as output, one or more signals indicating representing a count of one or more qualifying input conditions. For example, the term “counter” can refer to a ripple counter.

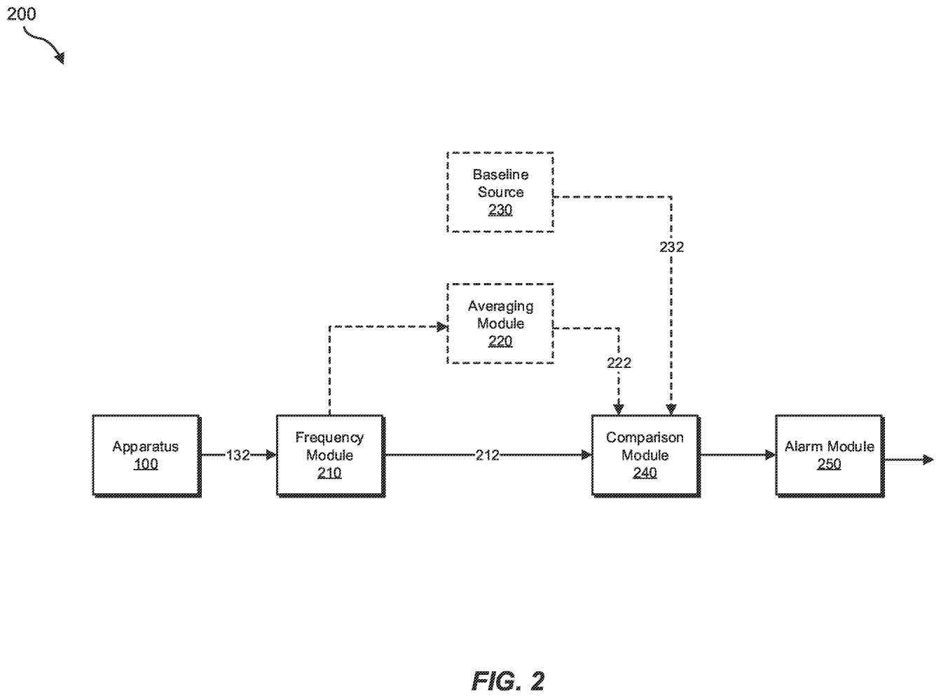

FIG. 2 is a block diagram of an example apparatus 200 for relaxation-oscillator-based thermal sensing. As shown in FIG. 2, apparatus 200 can include apparatus 100, a frequency module 210, a comparison module 240, and/or an alarm module 250. In addition, in some variations, apparatus 200 can include an averaging module 220 and/or a baseline source 230.

Frequency module 210 can produce a frequency based on count difference 132. For example, frequency module 210 can divide count difference 132 by a period of time to output a current temperature value 212. In some implementations, frequency module 210 can achieve dividing count difference 132 into periods of time to produce a frequency value (that, e.g., acts as a proxy for temperature) by periodically resetting counters 114 and 124 (e.g., as shown in FIG. 1) of apparatus 100. For example, frequency module 210 can provide a frequency value every 10 microseconds or more frequently, every 5 microseconds or more frequently, every 2 microseconds or more frequently, etc., and then reset counters 114 and 124. In some examples, frequency module 210 can produce a value representing a current frequency difference between relaxation oscillators 112 and 122.

In some implementations, comparison module 240 can compare current temperature value 212 with one or more other temperature values. For example, an averaging module 220 can average sampled frequency values from frequency module 210 over a period of time to produce an average temperature value 222. Thus, for example, averaging module 220 can calculate a running average of the last K samples, where K can be any suitable value. For example, averaging module 220 can calculate a running average of the last 5 samples, of the last 100 samples, etc. In some implementations, K can be a programmable value. In one variation, comparison module 240 can compare current temperature value 212 with average temperature value 222.

In another variation, comparison module 240 can compare current temperature value 212 with a baseline temperature value 232 from a baseline source 230. For example, baseline source 230 can be a known “cool spot” on a chip with a reliably cool and/or stable temperature. In some examples, baseline temperature value 232 can be written to a register space for use in apparatus 200. In some variations, baseline temperature value can be produced by an instance of apparatus 100 at baseline source 230.

Based on the results from comparison module 240, alarm module 250 can generate an alarm signal 252. For example, if current temperature value 212 exceeds the reference value (e.g., average temperature value 222 or baseline temperature value 232) by more than a predetermined threshold, alarm module 250 can generate alarm signal 252.

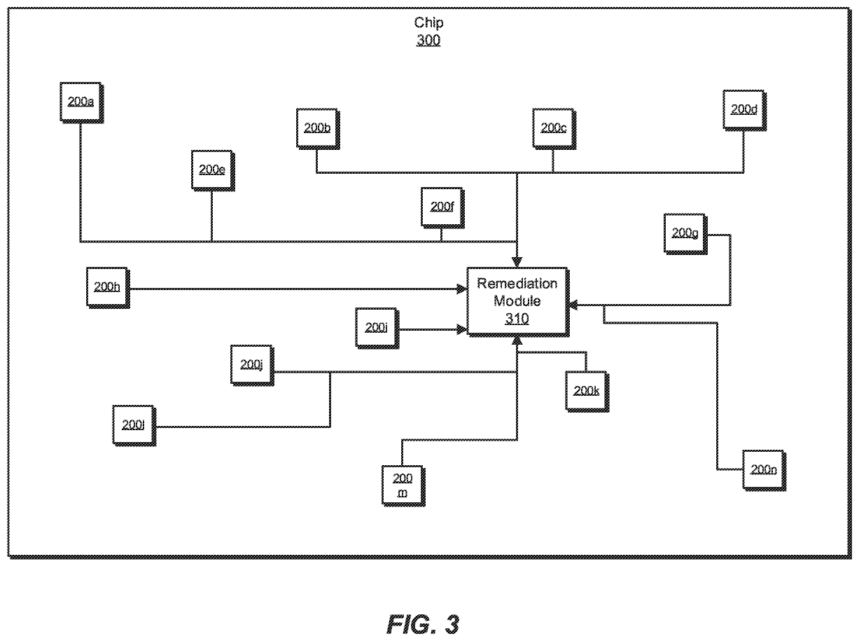

FIG. 3 is a block diagram of an example chip 300 incorporating multiple instances of apparatus 200 of FIG. 2. Chip 300 can be any type of device that can be subject to thermal monitoring and/or management. Examples of chip 300 include without limitation, a processor, a processor core, a hardware accelerator, a system-on-chip, a graphics processing unit, a field-programmable gate array, an application-specific integrated circuit, a random-access memory device, and a solid-state drive.

As shown in FIG. 3, instances 200a-n of apparatus 200 can be distributed across chip 300. While fourteen instances of apparatus 200 are depicted in FIG. 2, a chip can include any suitable number of instances of apparatus 200. Examples of the number of instances of apparatus 200 that can be included on a chip include, without limitation, five or more, 10 or more, 15 or more, 20 or more, 25 or more, and 30 or more.

In some variations, a high number of instances of apparatus 200 can be placed on a single chip due to attributes of apparatus 200. For example, apparatus 200 can take a small area on the chip, potentially reducing design constraints in including apparatus 200 in any given location of the chip. Additionally or alternatively, apparatus 200 can use only low-level metals. For example, a metal stack of a chip that includes apparatus 200 can have a metal stack with several metal layers. Examples of metal stack sizes of such a chip include, without limitation, 6 or more metal layers, 10 or more metal layers, 15 or more metal layers, 20 or more metal layers, 25 or more metal layers, and 30 or more metal layers. For any of the foregoing metal stack examples, an instance of apparatus 200 in the corresponding chip can reside in only lower metal layers. Examples of metal layers to which apparatus 200 can be contained include, without limitation, the fifth metal layer and lower, the fourth metal layer and lower, and the third metal layer and lower. In some implementations, a high number of instances of apparatus 200 can be placed on a chip at least in part due to the instances of apparatus 200 using only digital voltage and not analog voltage, thereby potentially reducing chip design constraints.

As shown in FIG. 3, chip 300 can also include a remediation module 310. In some examples, remediation module 310 can receive one or more alarm signals from one or more instances 200a-n of apparatus 200 when the corresponding instance senses a sufficiently high temperature. In response, remediation module 310 can perform one or more remediation actions. For example, remediation module 310 can reduce a clock speed of chip 300 and/or one or more other devices that can interact with chip 300 (e.g., such that the temperature of chip 300 would increase). Additionally or alternatively, remediation module 310 can reduce a voltage supply to chip 300. In some implementations, remediation module 310 can throttle at least one task performed by chip 300 (e.g., one or more instructions to be executed by chip 300).

In some implementations, remediation module 310 can represent one or more circuits that, when activated, can perform at least a portion of one or more of the tasks described above and/or that can send a signal to another device to perform at least a portion of one or more of the tasks described above. In some variations, at least a portion of remediation module 310 can be implemented as computer-executable instructions (e.g., stored in a memory device and executed by a hardware processor). Additionally or alternatively, remediation module 310 can interface with the memory device and/or hardware processor that store and execute computer-executable instructions to perform one or more thermal remediation tasks.

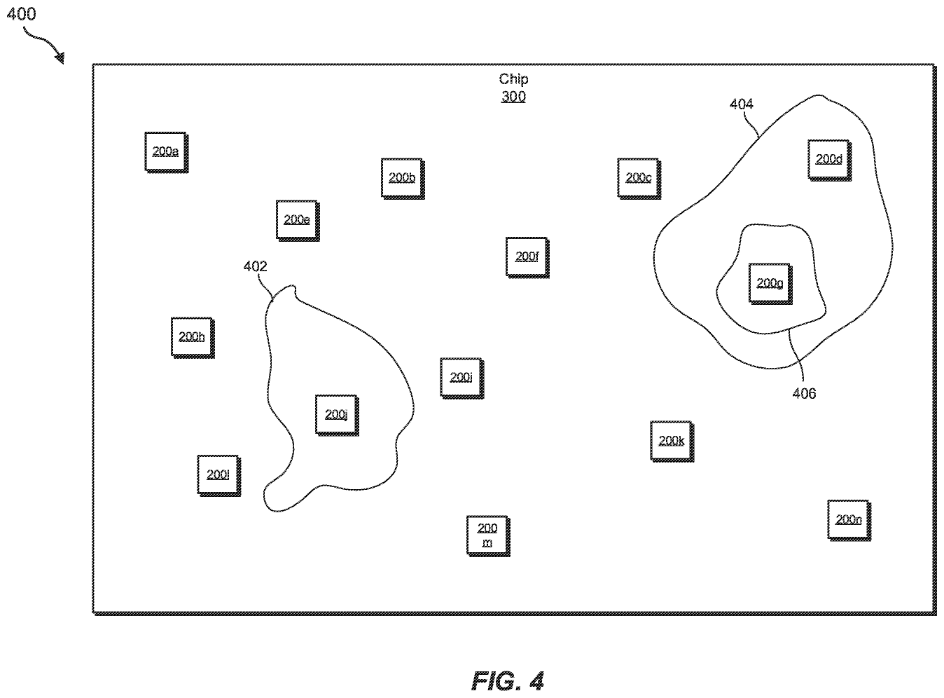

FIG. 4 is a block diagram illustrating hotspots on example chip 300 of FIG. 3. As shown in FIG. 4, chip 300 can be subject to multiple hotspot areas, such as a hotspot 402, a hotspot 404, and a hotspot 406. In one example, hotspot 406 can represent a higher temperature than hotspots 402 and 404. As used herein, the term “hotspot” can refer to any area within a device where the temperature of the area can potentially affect the reliability and/or performance of the device, can indicate a potential future impact on the reliability and/or performance of the device, and/or that is above a predetermined threshold. As can be appreciated from FIG. 4, while hotspots 402, 404, and 406 can be detected and remediated by the apparatuses and systems described herein, in a variation with fewer thermal sensors hotspots 402, 404, and/or 406 could be missed until the temperature of chip 300 is higher. For example, in a variation where the only thermal sensor on chip 300 is instance 200f, or where the only thermal sensors on chip 300 are 200e, 200c, and 200m, hotspots 402, 404, and 406 could go undetected until, e.g., they grow sufficiently. The higher density of thermal sensors can potentially allow for quicker, more efficient, and/or more effective thermal management.

In some examples, a thermal management system (including, e.g., remediation module 310 of FIG. 3) can respond to alarms generated by Instances 200a-m based at least in part on the number of instances generating alarms (e.g., within a given time window), the severity of the hotspots, and/or the absolute and/or relative locations of the instances that generate the alarms. Thus, for example, in some variations a thermal management system can perform one or more remediation actions at a lower temperature threshold, with a higher degree of response (e.g., a greater reduction to the clock rate and/or for a longer period of time, a greater reduction to voltage and/or for a longer period of time, a greater number of instructions throttled and/or for a longer period of time, etc.) based on there being three sensors detecting hotspots (rather than, e.g., just one) and/or based on hotspot 406 exceeding a higher threshold than, e.g., hotspots 402 or 404. In one variation, a thermal management system can, based on the proximity of instances 200g and 200d, infer hotspot 404 to be relatively large (and thus, e.g., more difficult to dissipate). In response, the thermal management system can perform one or more remediation actions at a lower temperature threshold than otherwise and/or can perform them with a higher degree of response, as in the examples provided above. In some variations, a thermal management system can select a type and/or degree of remediation action based on the location of thermal sensors reporting hotspots. For example, a thermal management system can, based on the location of instance 200d on chip 300, reduce clock speed rather than voltage (or vice versa) in response to an alarm from instance 200d.

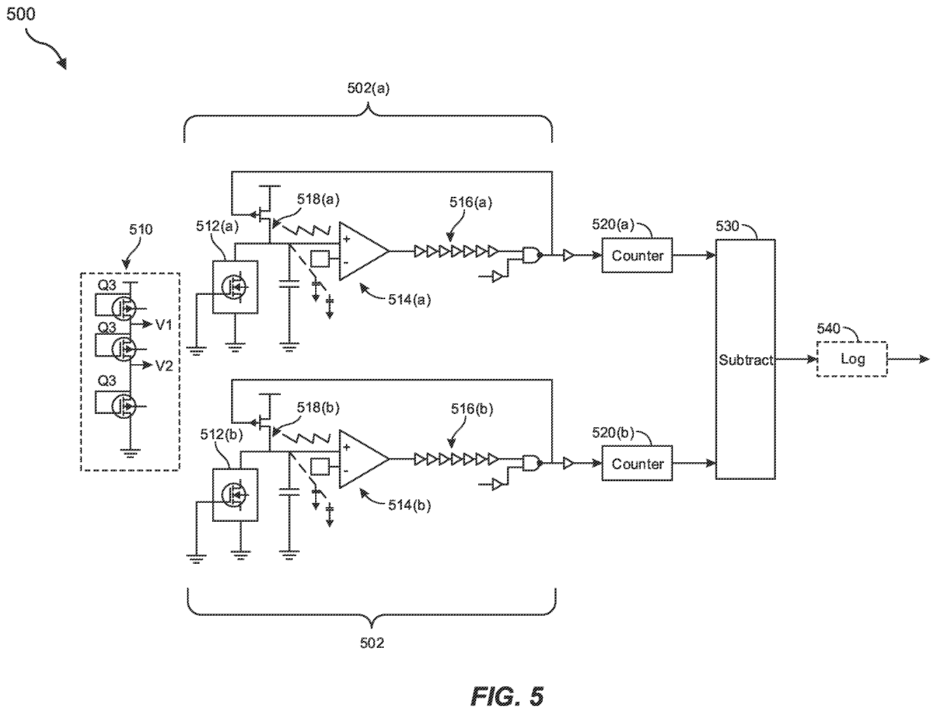

FIG. 5 is a diagram of an example circuit 500 for relaxation-oscillator-based thermal sensing. As shown in FIG. 5, circuit 500 can include a relaxation oscillator 502(a), a relaxation oscillator 502(b), a voltage divider 512 (in some variations), a subtraction module 530, and, in some variations, a log module 540. Relaxation oscillator 502(a) can include a metal-oxide-semiconductor field-effect transistor (MOSFET) 512(a), a voltage comparator 514(a), a reset delay 516(a), a node 518(a), and a counter 520(a). Relaxation oscillator 502(b) can include a MOSFET 512(b), a voltage comparator 514(b), a reset delay 516(b), a node 518(b), and a counter 520(b). As used herein, the term “reset delay” can refer to any circuit element that delays a signal (e.g., that, inter alia, resets an oscillating voltage). For example, a reset delay can be implemented as one or more non-inverting buffers in series.

As can be appreciated from FIG. 5, relaxation oscillators 502(a) and 502(b) can have similar designs. Thus, for example, relaxation oscillators 502(a) and 502(b) can share the same or similar topologies, the same or similar set of components, and/or the same or similar layouts. However, as discussed earlier, certain aspects of relaxation oscillators 502(a) and 502(b) can differ. For example, relaxation oscillators 502(a) and 502(b) can be configured to have different oscillation frequencies. In one example, this can be accomplished via a difference in elements 512(a) and 512(b). For example, MOSFET 512(a) and MOSFET 512(b) can be configured to leak charge at different rates. While FIG. 5 illustrations circuit 500 with MOSFETs 512(a) and 512(b), any suitable element can be used to discharge nodes 518(a) and 518(b), respectively. For example, in place of MOSFET 512(a) and/or MOSFET 512(b), circuit 500 could include a resistor. In this variation, the discharging element in relaxation oscillator 502(a) can discharge node 518(a) at a different rate than the discharging element in relaxation oscillator 502(b) discharges node 518(b). Thus, it may be appreciated that in various examples provided herein in which a MOSFET is used as a discharging element, other discharging elements may be used instead.

In addition to or instead of MOSFETs 512(a) and 512(b) discharging nodes 518(a) and 518(b) at different rates, voltage comparators 514(a) and 514(b) can use different reference voltages for comparing with the voltages of nodes 518(a) and 518(b), respectively. For example, as shown in FIG. 5, voltage divider 510 can produce a voltage V1 and a voltage V2. In one example, voltage comparator 514(a) can compare the voltage of node 518(a) with voltage V1 while voltage comparator 514(b) can compare the voltage of node 518(b) with voltage V2. In this manner, relaxation oscillators 502(a) and 502(b) can oscillate at different frequencies. In Reset delays 516(a) and 516(b) can delay the signals from voltage comparators 514(a) and 514(b), respectively. In some variations, reset delays 516(a) and 516(b) can differ.

Counter 520(a) can count oscillations of relaxation oscillator 502(a) (e.g., by counting each time the voltage of node 518(a) drops below the reference voltage). Likewise, counter 520(b) can count oscillations of relaxation oscillator 502(b). Subtraction module 530 can subtract counter 520(b) from counter 520(a) to produce a value indicating a difference in frequency of relaxation oscillators 502(a) and 502(b). Because the magnitude of the difference of the frequencies of relaxation oscillators 502(a) and 502(b) can be attributed to temperature-induced leakage rates (other factors that potentially influence oscillation frequency being controlled for by the parallel designs of relaxation oscillators 502(a) and 502(b)), the output of subtraction module 530 can largely represent temperature. In some variations, counters 520(a) and 520(b) can periodically reset. Counters 520(a) and 520(b) can be implemented in any suitable manner. In some variations, counters 520(a) and 520(b) can include ripple counters.

In some variations, a log module 540 can calculate a logarithm of the count difference produced by subtraction module 530. In some implementations, the logarithm of the count difference can, for temperature ranges of interest, have an approximately linear relationship with temperature.

FIG. 6 is an illustration of example oscillations of an apparatus for relaxation-oscillator-based thermal sensing. As shown in FIG. 6, a function 602 can show the oscillation of a relaxation oscillator (e.g., relaxation oscillator 502(a) of FIG. 5). Function 602 can also show the oscillation of a relaxation oscillator (e.g., relaxation oscillator 502(b) of FIG. 5). As can be appreciated from FIG. 6, function 602 demonstrates a higher frequency, owing to the oscillations resetting at a higher voltage threshold 610, whereas function 604 demonstrates a lower frequency, owing to the oscillations resetting at a lower voltage threshold 612. A difference 606 demonstrates how much longer a full oscillation of function 604 takes than a full oscillation of function 602. As temperature affects the frequencies of oscillation of both functions 602 and 604 (e.g., due to steeper voltage drops), so too it can affect the frequency difference between functions 602 and 604.

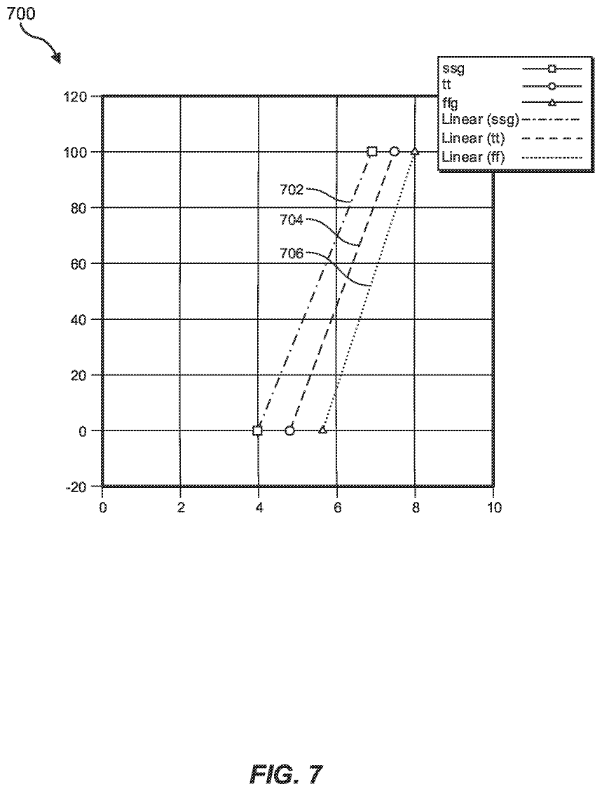

FIG. 7 is an illustration of an example correspondence between oscillations and temperature. As shown in FIG. 7, linear fits between a logarithm of count differentials from a pair of relaxation oscillators (e.g., an output from log module 540 of FIG. 5) and temperature can approximate temperatures (e.g., as illustrated, between 0 and 100 degrees Celsius) for a range of outputs from a relaxation-oscillator-based thermal sensor, such as circuit 500 of FIG. 5. FIG. 7 shows example linear fits for three process corners: a linear fit 702 for a slow-slow corner, a linear fit 704 for a typical-typical corner, and a linear fit 706 for a fast-fast corner.

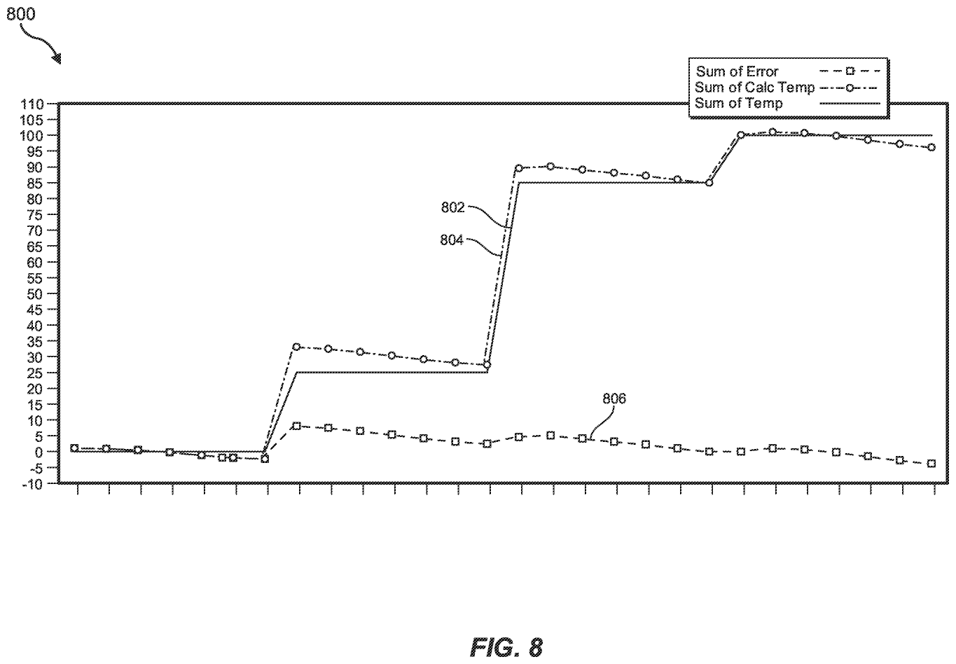

FIG. 8 is an illustration of an example temperature measurements 800 by an example apparatus for relaxation-oscillator based thermal sensing. As shown in FIG. 8, the temperature 802 at a sensor can increase in steps over time. Based on a conversion 804 of the sensor's output to a temperature value (e.g., based on a linear fit such as that shown in FIG. 7), the sensor's output can closely track temperature 802, varying only by an error 806.

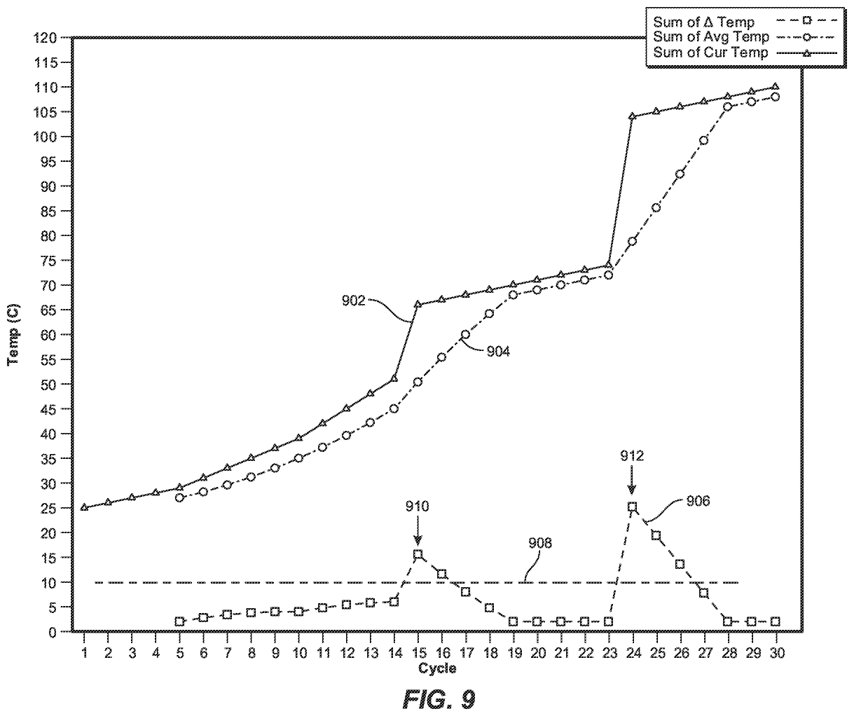

FIG. 9 is an illustration of an example thermal alarm by an example apparatus for relaxation-oscillator based thermal sensing. As shown in FIG. 9, the sensed current temperature 902 at a sensor can increase over time. Likewise, the calculated running average temperature 904 can increase over time. A calculated difference 906 between the current temperature 902 and the running average temperature 904 can show spikes when the current temperature 902 quickly rises. A threshold 908 can be set (e.g., to 10 degrees Celsius). Thus, when calculated difference 906 spikes above threshold 908 (e.g., at point 910 and at point 912), systems, apparatuses, and methods described herein can generate an alarm signal for a thermal remediation system.

FIG. 10 is a flow diagram of an example method for relaxation-oscillator based thermal sensing. The steps shown in FIG. 10 can be performed by any suitable apparatus, device, or system, including apparatus 100 of FIG. 1, apparatus 200 of FIG. 2, chip 300 of FIG. 3, and circuit 500 of FIG. 5, and/or variations or combinations of one or more of the same.

As illustrated in FIG. 10, at step 1002 one or more of the apparatuses described herein can produce a first oscillating voltage via a first relaxation oscillator. For example, relaxation oscillator 502(a) of FIG. 5 can produce an oscillating voltage at node 518(a). In one variation, this can be accomplished as MOSFET 512(a) leaks charge from node 518(a) until the voltage at 518(a) reaches a can voltage, as determined by voltage comparator 514(a). The output of voltage comparator 514(a) can then cause the voltage at node 518(a) to flip back to the full source voltage.

At step 1004, one or more of the apparatuses described herein can count a first number of oscillations of the first oscillating voltage. For example, counter 520(a) of FIG. 5 can count the number of oscillations of the oscillating voltage of relaxation oscillator 502(a).

At step 1006, one or more of the apparatuses described herein can produce a second oscillating voltage via a second relaxation oscillator. For example, relaxation oscillator 502(b) of FIG. 5 can produce an oscillating voltage at node 518(b). In one variation, this can be accomplished as MOSFET 512(b) leaks charge from node 518(b) until the voltage at 518(b) reaches a reference voltage, as determined by voltage comparator 514(b). The output of voltage comparator 514(b) can then cause the voltage at node 518(b) to flip back to the full source voltage.

At step 1008, one or more of the apparatuses described herein can count a second number of oscillations of the second oscillating voltage. For example, counter 520(b) of FIG. 5 can count the number of oscillations of the oscillating voltage of relaxation oscillator 502(b).

At step 1010, one or more of the apparatuses described herein can subtract the second number of oscillations from the first number of oscillations to generate a count difference. For example, subtraction module 530 of FIG. 5 can subtract the value of counter 520(b) from the value of counter 520(a). The output of subtraction module 530 can function as an initial proxy for temperature sensed by circuit 500.

While the foregoing disclosure sets forth various examples of implementations and variations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered example in nature since many other architectures can be implemented to achieve the same functionality.

According to certain implementations, all or a portion of example apparatus 100 in FIG. 1 can be implemented within a simulated environment. For example, the modules described herein can be implemented in a hardware (e.g., circuit) simulator.

The process parameters and sequence of steps described and/or illustrated herein are given by way of example only and can be varied as desired. For example, while the steps illustrated and/or described herein can be shown or discussed in a particular order, these steps do not necessarily need to be performed in the order illustrated or discussed. The various example methods described and/or illustrated herein can also omit one or more of the steps described or illustrated herein or include additional steps in addition to those disclosed.

The preceding description has been provided to enable others skilled in the art to best utilize various aspects of the example implementations and variations disclosed herein. This example description is not intended to be exhaustive or to be limited to any precise form disclosed. Many modifications and variations are possible without departing from the spirit and scope of the present disclosure. The implementations and variations disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. An apparatus for relaxation-oscillator-based thermal sensing, the apparatus comprising:
a first oscillation count module comprising a first counter configured to count a first number of oscillations produced by a first relaxation oscillator;
a second oscillation count module comprising a second counter configured to count a second number of oscillations produced by a second relaxation oscillator; and
a subtraction module configured to subtract the second number of oscillations from the first number of oscillations to generate a count difference.

2. The apparatus of claim 1, wherein the first oscillation count module and the second oscillation count module are adjacent to each other.

3. The apparatus of claim 1, wherein:
the first oscillation count module further comprises the first relaxation oscillator, the first relaxation oscillator being configured to produce a first oscillating voltage; and
the second oscillation count module further comprises the second relaxation oscillator, the second relaxation oscillator being configured to produce a second oscillating voltage.

4. The apparatus of claim 3, wherein:
the first relaxation oscillator comprises a first voltage comparator configured to compare the first oscillating voltage with a first reference voltage, wherein the first counter is configured to count an oscillation based on output from the first voltage comparator; and
the second relaxation oscillator comprises a second voltage comparator configured to compare the second oscillating voltage with a second reference voltage, wherein the second counter is configured to count an oscillation based on output from the second voltage comparator.

5. The apparatus of claim 4, wherein the first reference voltage and the second reference voltage differ.

6. The apparatus of claim 4, wherein a rate of discharge of the first relaxation oscillator differs from a rate of discharge of the second relaxation oscillator.

7. The apparatus of claim 4, wherein:
the first oscillation count module further comprises a first reset delay element configured to delay an output signal from the first voltage comparator; and
the second oscillation count module further comprises a second reset delay element configured to delay an output signal from the second voltage comparator.

8. The apparatus of claim 7, wherein a first reset delay element and the second reset delay element are configured to differ to produce differing delays.

9. The apparatus of claim 3, wherein the first oscillation count module and the second oscillation count module have substantially the same design except for at least one of:
differing rates of discharge for the first and second relaxation oscillators;
differing reference voltages used by a first voltage comparator of the first relaxation oscillator and a second voltage comparator of the second relaxation oscillator; or
differing reset delays.

10. The apparatus of claim 1, wherein the apparatus is configured to occupy only metal layers in a metal stack at or below a fourth metal layer.

11. The apparatus of claim 1, wherein the apparatus is configured to use digital voltage and not to use analog voltage.

12. The apparatus of claim 1, wherein:
the first relaxation oscillator comprises a first metal-oxide-semiconductor field-effect transistor configured to leak charge; and
the second relaxation oscillator comprises a second metal-oxide-semiconductor field-effect transistor configured to leak charge.

13. The apparatus of claim 1, further comprising a frequency module configured to divide the count difference by a period of time to output a current temperature value.

14. The apparatus of claim 13, further comprising an averaging module configured to average the current temperature value over a period of time to output an average temperature value.

15. The apparatus of claim 14, further comprising a comparison module configured to:
compare the average temperature value with the current temperature value; and
generate a temperature alarm signal in response to the current temperature value exceeding the average temperature value by a predetermined amount.

16. The apparatus of claim 13, further comprising a comparison module configured to:
compare the average temperature value with a baseline temperature value; and
generate a temperature alarm signal in response to the current temperature value exceeding the baseline temperature value by a predetermined amount.

17. A semiconductor chip device comprising:
at least one logic circuit structure; and
a thermal sensor comprising:
a first oscillation count module comprising a first counter configured to count a first number of oscillations produced by a first relaxation oscillator;
a second oscillation count module comprising a second counter configured to count a second number of oscillations produced by the second relaxation oscillator; and
a subtraction module configured to subtract the second number of oscillations from the first number of oscillations to generate a count difference.

18. The semiconductor chip device of claim 17, further comprising an alarm module configured to generate, based at least in part on the count difference, a temperature alarm signal.

19. The semiconductor chip device of claim 18, further comprising a remediation module configured to, in response to the temperature alarm signal, perform a remediation action.

20. A method for relaxation-oscillator-based thermal sensing, the method comprising:
producing a first oscillating voltage via a first relaxation oscillator;
counting a first number of oscillations of the first oscillating voltage;
producing a second oscillating voltage via a second relaxation oscillator;
counting a second number of oscillations of the second oscillating voltage; and
subtracting the second number of oscillations from the first number of oscillations to generate a count difference.
